(19) United States
(12) Patent Application Publication
(10) Pub. No.: US 2010/0182193 A1
(43) Pub. Date: Jul. 22, 2010

(54) DATA PROCESSING SYSTEM AND METHOD INTEGRATED WITH POSITIONING TECHNOLOGY

(75) Inventors: Yeong-Sung Lin, Taipei (TW); Eric Chen, Taipei (TW); Wei-Chih Lai, Taipei (TW); Ming-Long Lyu, Taipei (TW); I-Kai Wang, Taipei (TW); Yi-Tien Tsai, Taipei (TW); Ting-Ying Huang, Taipei (TW); Wei Hsiang, Taipei (TW); Chun-Wei Fan Chiang, Taipei (TW); Jui-Pin Lo, Taipei (TW)

Correspondence Address: EDWARDS ANGELL PALMER & DODGE LLP, P.O. BOX 55874, BOSTON, MA, 02205, US

(73) Assignee: NATIONAL TAIWAN UNIVERSITY, Taipei (TW)

(21) Appl. No.: 12/503,172

(22) Filed: Jul. 15, 2009

(30) Foreign Application Priority Data
Jan. 21, 2009 (TW) 989102189

(51) Int. Cl. G01S 1/00

(52) U.S. Cl. 342/357.1

(57) ABSTRACT

A data processing system and method integrated with positioning technology are provided. A plurality of mobile devices perform data processing on positioning signals received from a positioning device. The mobile devices together form at least a communication group. One of the mobile devices receives coordinate information from the other one or more of the plurality of mobile devices of the at least a communication group via a wireless signal transceiver module. A data computation module performs computation on the coordinate information to obtain group information, and transmits the group information via the wireless signal transceiver module such that all of the plurality of mobile devices of the at least a communication group are allowed to obtain the group information. Known problems, that is, conventional mobile devices fail to receive coordinate information from one another and thereby fail to interact with one another, are solved by the system and method.

### BACKGROUND OF THE INVENTION

1. Field of the Invention

The present invention relates generally to a data processing system and method integrated with positioning technology, and more particularly, to a data processing system and method through which mobile devices exchange coordinate information with one another so as to interact with one another.

2. Description of Related Art

In social activities, it is often necessary to determine locations or coordinates. As a result, a variety of positioning techniques have been developed. Currently, wireless radio wave signals ranged from GSM, to 3G and WIFI signals are utilized for positioning handheld users. Because these techniques have not yet matured, there are few associated products or applications on the market.

The global positioning system (GPS) is a positioning technique developed by the United States originally for military purposes, but has now been widely applied in resource investigation and detection, navigation positioning, geodetic surveying, charting, dynamic location informing, precise timing and so on. For example, through computation of a GPS signal receiver in combination with a map database, the location of a user can be instantly displayed. Such an operating method is also used in general map information update systems such as GPS navigation systems. However, the major drawback of using the GPS system lies in its low accuracy. The error range of the system may reach 5-10 meters and therefore its application becomes quite limited.

The Galileo satellite system is the world's first global satellite navigation and positioning system for civil purposes. It realizes a non-military control and management system and provides navigation and positioning services on a global scale with high accuracy and reliability. Particularly, it can locate a 1-meter object and provide better accuracy than the GPS system developed by the United States.

Nevertheless, there are still some drawbacks in the prior art:
(1) Users cannot interact with one another. In the prior art, users can only receive positioning signals through positioning signal receiving devices passively, but not data from one another for further interaction.
(2) The application of positioning technology is limited. Constrained by its structure, the conventional positioning technology can only be applied to individual navigation, positioning or dynamic location queries, but not to multiple users.

Therefore, there is a need to provide a data processing system and method that integrate mobile devices with positioning technology so as to overcome the above technical problems.

### SUMMARY OF THE INVENTION

According to the above drawbacks, the present invention provides a data processing system and method that integrate mobile devices with positioning technology such that the mobile devices can receive coordinate information from one other, thereby expanding the application area of the positioning technology.

In order to achieve the above and other objects, the present invention provides a data processing system integrated with positioning technology, which comprises: a positioning device for sending positioning signals; and a plurality of mobile devices for processing, receiving and transmitting data, wherein each of the plurality of mobile devices comprises: a positioning signal processing module for receiving the positioning signals to generate coordinate information; a wireless signal transceiver module for receiving and transmitting wireless signals; and a data computation module for computing the coordinate information, wherein the plurality of mobile devices form at least a communication group, allowing one of the plurality of mobile devices of the at least a communication group to receive the coordinate information from the other one or more of the plurality of mobile devices of the at least a communication group via the wireless signal transceiver module, so as for the data computation module to compute the coordinate information to obtain group information and then transmit the group information via the wireless signal transceiver module, such that all of the plurality of mobile devices of the at least a communication group are allowed to obtain the group information.

In a preferred embodiment, one of the plurality of mobile devices is provided with a talk function for transmitting data to one another via the wireless signal transceiver module. One of the plurality of mobile devices receives the coordinate information from the other one or more of the plurality of mobile devices via the talk function and computes the coordinate information according to specific processing procedures so as to generate the group information and then transmit the group information to the other one or more of the plurality of mobile devices.

In another embodiment, the data processing system of the present invention further comprises a data processing platform for receiving the coordinate information from the plurality of mobile devices and computing the coordinate information according to specific processing procedures so as to obtain the group information and then transmit the group information to the plurality of mobile devices.

The present invention further provides a data processing method integrated with positioning technology, which is applied to a system having a positioning device and a plurality of mobile devices. The data processing method comprises the steps of: (1) commanding the plurality of mobile devices to form at least a communication group; (2) commanding the plurality of mobile devices to receive positioning signals from the positioning device to generate coordinate information; (3) commanding one of the plurality of mobile devices to receive the coordinate information from the other one or more of the plurality of mobile devices of the at least a communication group via a wireless transmission approach; and (4) commanding the one of the plurality of mobile devices to compute the coordinate information according to specific processing procedures to obtain group information and then transmit the group information to the other one or more of the plurality of mobile devices of the at least a communication group.

The present invention further provides a data processing method integrated with positioning technology, which is applied to a system having a positioning device, a plurality of mobile devices and a data processing platform. The method comprises the steps of: (1) commanding the plurality of mobile devices to form at least a communication group; (2) commanding the plurality of mobile devices of the at least a communication group to receive positioning signals from the positioning device to generate coordinate information; (3) commanding the plurality of mobile devices of the at least a communication group to transmit the coordinate information to the data processing platform via a wireless transmission method; and (4) commanding the data processing platform to compute the coordinate information according to specific processing procedures so as to obtain group information and then transmit the group information to the plurality of mobile devices of the at least a communication group.

In light of the data processing system and method of the present invention, a plurality of mobile devices can form a communication group, transmit coordinate information therebetween and compute the coordinate information through specific processing procedures, thereby expanding the application area of the positioning technology and enhancing interaction among users.

### BRIEF DESCRIPTION OF DRAWINGS

FIG. 1 is a diagram showing the structure of a data processing system integrated with positioning technology according to the present invention;

FIG. 2 is a diagram showing the structure of a data processing system integrated with positioning technology according to an embodiment of the present invention;

FIG. 3 is a diagram showing the structure of a data processing system integrated with positioning technology according to another embodiment of the present invention;

FIG. 4 is a diagram showing the structure of a data processing system applied in an urban game according to an embodiment of the present invention;

FIG. 5 is a diagram showing a framework of a data processing system applied in an urban game according to another embodiment of the present invention;

FIG. 6 is a flow chart showing a data processing method integrated with positioning technology according to an embodiment of the present invention;

FIG. 7 is a flow chart showing a data processing method integrated with positioning technology according to another embodiment of the present invention; and

FIG. 8 is a flow chart showing a data processing method applied in an urban game according to an embodiment of the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

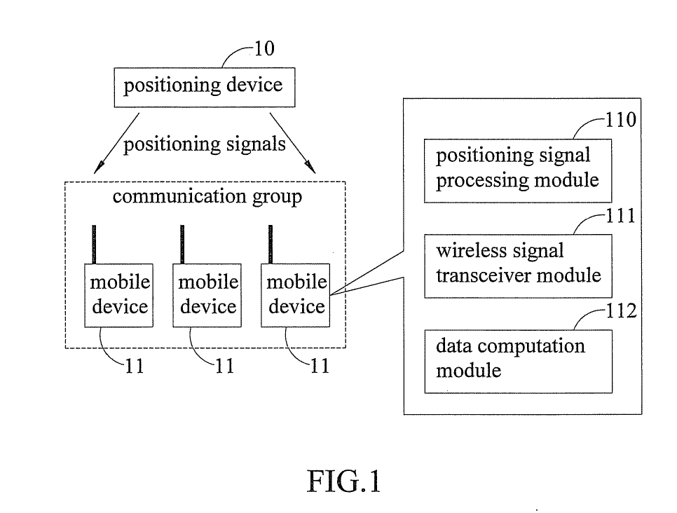

FIG. 1 is a diagram showing the structure of a data processing system integrated with positioning technology. As shown in the diagram, the system comprises a positioning device 10 and a plurality of mobile devices 11, wherein each of the plurality of mobile devices 11 comprises a positioning signal processing module 110, a wireless signal transceiver module 111 and a data computation module 112.

The positioning device 10 is used for sending positioning signals such that users can receive the positioning signals for determining their own locations. The positioning device can be such as a GPS positioning satellite, a Galileo satellite, a wireless network positioning device or a mobile communication base station. For example, users with GPS receivers can receive positioning signals sent by a GPS positioning satellite so as to determine their own locations or coordinates.

The plurality of mobile devices 11 are used for processing, receiving and transmitting data. The plurality of mobile devices 11 are smart phones, PDAs or portable computers. Each of the plurality of mobile devices 11 further comprises different kinds of functional modules as described below.

The positioning signal processing module 110 is used to receive positioning signals from the positioning device to generate coordinate information. The positioning signals refer to information that can determine locations of devices that receive signals. For example, signals sent by a GPS satellite are positioning signals and signals sent by general wireless communication base stations can also function as positioning signals. In addition, signals sent by access points of wireless local area networks within their operation range also belong to positioning signals.

The wireless signal transceiver module 111 is used for receiving and transmitting wireless signals. The wireless signal transceiver module 111 can receive and transmit wireless LAN signals or wireless WAN signals. A 2G, 2.5G or 3G communication module in the current market can be used as the wireless signal transceiver module 111.

The data computation module 112 is used for computing the coordinate information so as to obtain data related to the coordinate information, for example, path prediction data or relative position data.

In practice, the plurality of mobile devices 11 form at least one communication group, allowing one of the plurality of mobile devices 11 of the at least one communication group to receive the coordinate information of the other one or more of the plurality of mobile devices 11 of the at least one communication group via the wireless signal transceiver module 111, so as for the data computation module 112 to compute the coordinate information so as to obtain group information and then transmit the group information via the wireless signal transceiver module 111, such that all of the plurality of mobile devices of the at least one communication group are allowed to obtain the group information. Therein, the group information may include status information, location information, grouping information, scoring information or motion strategy information of the plurality of mobile devices. By exchanging data among the plurality of mobile devices in combination with precise coordinate information, the plurality of mobile devices of the at least a communication group can identify relative positions to others, thereby allowing an urban game to be implemented in the present system.

In a preferred embodiment, if a plurality of communication groups are formed in the system, a mobile device is allowed to be selected to exchange the group information with the other one or more of the plurality of mobile devices of the other one or more of the at least one communication group, so as for the group information to be communicated among different ones of the at least one communication group.

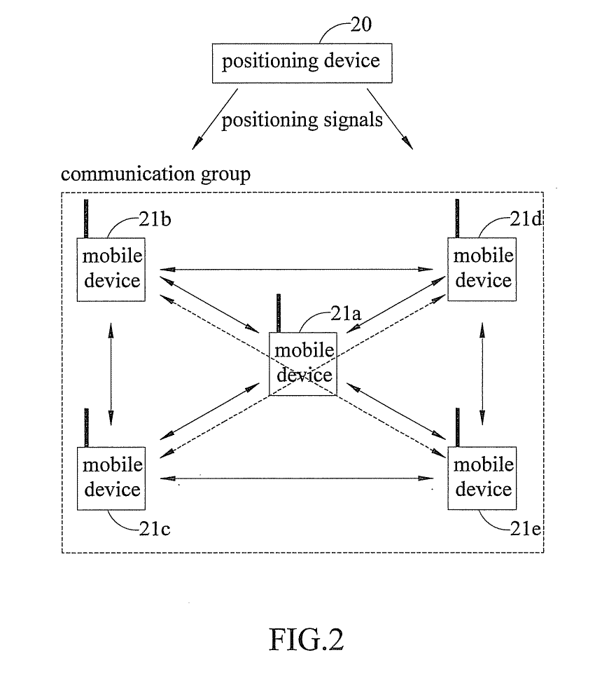

Referring to FIG. 2, a data processing system integrated with positioning technology according to an embodiment of the present invention is shown. As shown in the diagram, the system comprises a positioning device 20 and a plurality of mobile devices 21a, 21b, 21c, 21d and 21e.

Unlike the preceding embodiment illustrated with FIG. 1, in this embodiment, one of the plurality of mobile devices is provided with a talk or a broadcast function. The plurality of mobile devices receive coordinate information of the other one or more of the plurality of mobile devices by using the talk function thereof, and then computes the received coordinate information by using specific processing procedures so as to obtain group information and then transmits the group information to the other one or more of the plurality of mobile devices through the broadcast function thereof. For example, the mobile device 21a receives positioning signals sent by the positioning device 20 to generate coordinate information related to its own location. Meanwhile, the mobile device 21a actively talks with surrounding mobile devices 21b to 21e to obtain coordinate information of the mobile devices 21b to 21e and then computes the coordinate information so as to obtain group information. Thereafter, the mobile device 21a transmits the group information to the mobile devices 21b to 21e or one or more of the plurality of mobile devices by using a broadcasting means. In the present embodiment, the mobile devices can perform data processing respectively and exchange data through wireless networks. Alternatively, one of the mobile devices can be specified as a main computing device that receives coordinate information from the other one or more of the plurality of mobile devices for computing so as to form group information and then transmits the group information to the other one or more of the plurality of mobile devices.

In a preferred embodiment, one of the plurality of mobile devices is provided with a host function talks with the other one or more of the plurality of mobile devices for inviting them to join the at least a communication group.

In another preferred embodiment, the system of the present invention further comprises a coordinate reference device for receiving coordinate information of the plurality of mobile devices and computes the coordinate information according to specified processing procedures so as to obtain group information and then transmits the group information to the plurality of mobile devices. For example, the coordinate reference device may be a pointing device with a short-range sensor. When the coordinate reference device is applied to an urban game, it can find surrounding mobile devices through the short-range sensor thereof and exchange coordinate information, status information or game information with the plurality of mobile devices.

In another preferred embodiment, each of the plurality of mobile devices further comprises electronic map software for displaying relative position, moving path or route planning of the plurality of mobile devices of the at least one communication group according to the coordinate information.

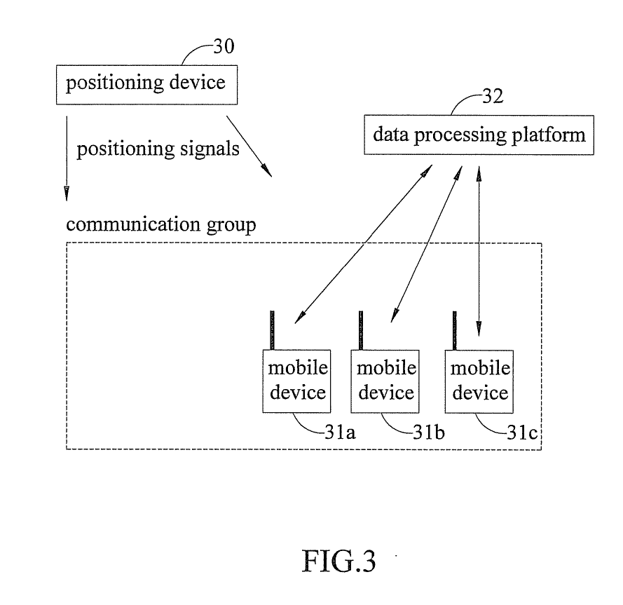

FIG. 3 shows the structure of a data processing system integrated with positioning technology according to another embodiment of the present invention. As shown in the diagram, the system comprises a positioning device 30, mobile devices 31a to 31c and a data processing platform 32.

Different from FIG. 1 and FIG. 2, the present embodiment performs centralized computation for data processing. The data processing platform 32 receives coordinate information of the plurality of mobile devices 31a to 31c and computes the coordinate information according to specific processing procedures so as to obtain group information and then transmits the group information to the plurality of mobile devices 31a to 31c. The data processing platform 32 may be a value-added service platform provided by a telecommunication company. The plurality of mobile devices transmit coordinate information to the value-added service platform for data computation and processing, thereby reducing computational loadings on the plurality of mobile devices and facilitate smooth operation of the whole system.

In a preferred embodiment, the processing procedures involve computing the received coordinate information according to software predefined flows, rules, or methods. In addition, different types of program software can be set by the plurality of mobile devices according to different game contents.

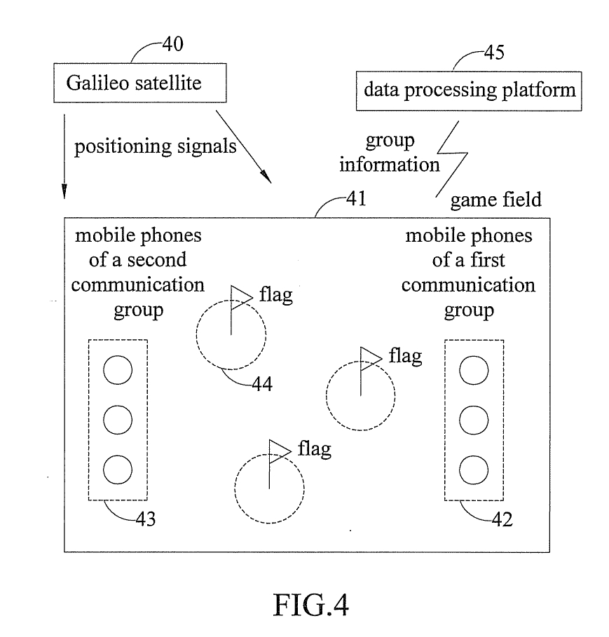

FIG. 4 shows the structure of the data processing system applied in an urban game according to an embodiment of the present invention. As shown in the diagram, the data processing system comprises a Galileo satellite 40, a game field 41, mobile phones of a first communication group 42, and mobile phones of a second communication group 43, flags 44 and a game data processing platform 45.

In the present embodiment, a flag capture game is conducted. Every player in the game has a mobile phone that can receive positioning signals from the Galileo satellite 40. When the players with mobile phones move in the game field 41, the plurality of mobile phones continuously send positioning signals to the game data processing platform 45. The game data processing platform 45 divides the players into a first communication group and a second communication group, and gathers statistics of number of the players around each flag 44 in a specific range, such as a 2-meter radius, at a specific time interval, such as one minute. The at least one communication group that includes more players around the flag will win a score. The plurality of mobile phones of the players continuously receive group information sent from the game data processing platform 45. Therefore, the players in a same communication group identify relative locations to one another so as to rapidly plan flag capture strategies accordingly. In addition, the game data processing platform 45 can output corresponding status information, location information, grouping information, scoring information or motion strategy information in line with the game rules and coordinate information of the players and then send the information to the plurality of mobile phones of the players to enrich and flavor the game content.

In a preferred embodiment, the plurality of mobile devices can be used in combination with transportation to increase its application variability of the present invention. In the above-described game, the players may install their mobile devices to the bicycles or beach carts so as to increase their moving range. In addition, different game rules and methods can be evolved according to the characteristics of rapid movement of the transportation to diversify the game.

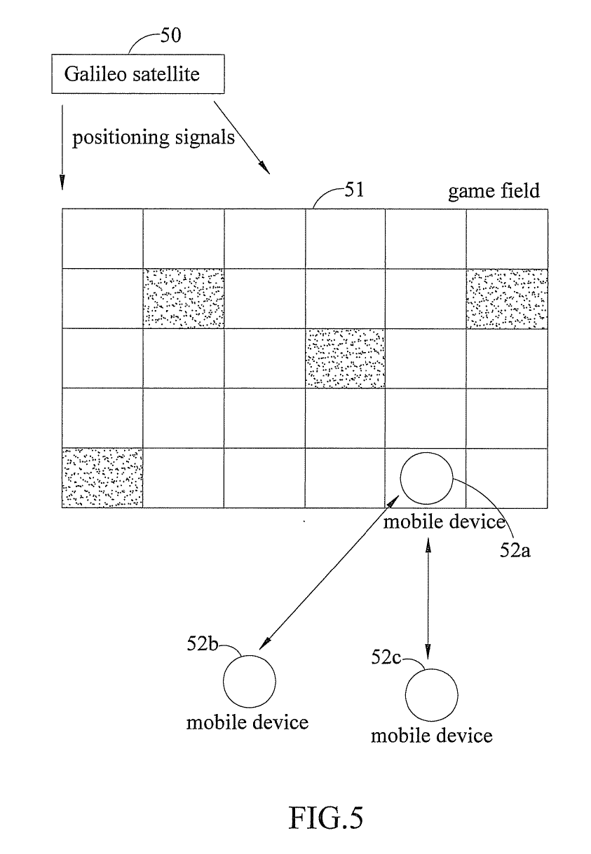

FIG. 5 shows a framework of a data processing system applied in an urban game according to another embodiment of the present invention. As shown in the drawing, the data processing system comprises a Galileo satellite 50, a game field 51 and mobile devices 52a to 52c.

In the present embodiment, a minesweeper game is conducted. Every game player has a mobile device that can receive positioning signals sent by the Galileo satellite 50. The game field is pre-divided into a plurality of coordinate blocks (30 coordinate blocks in the drawing) and specific coordinate blocks are defined as mine blocks (grey blocks in the drawing). Game players must determine which one of the coordinate blocks is a mine block. If they move to a mine block where the mine has not been removed, their mobile devices will show a mine explosion and game-over message. When the players remove mines in the mine blocks successfully, they win scores. The minesweeper game of the present embodiment can be designed as a multiplayer mode. First, a mobile device starts the game and serves as a game host. Then, the mobile device invites other game players to join the game through a talk function for transmitting data to one another via the wireless signal transceiver module thereof. For example, the mobile device 52a is the game host, which sends invitation messages to the other mobile devices 52b and 52c. As the mobile devices 52b and 52c send confirmation messages back to the mobile device 52a, the mobile device 52a adds the mobile devices 52b and 52c to the same communication group such that game players can interact with one another during the game.

In a multi-player mode, game rules can be set as that the quicker a player remove the mines, the higher score he wins, thereby making the competition more interesting.

In a preferred embodiment, game players are divided into a plurality of groups that play the game at the same time. When game players of a same group remove the correct mines, the group score will be increased; on the other hand, when a game player mistakenly steps on mines, the group score will be decreased or the game player will quit the game. Finally, a total group score or a total number of players in a group is compared to one another for determining the winning group.

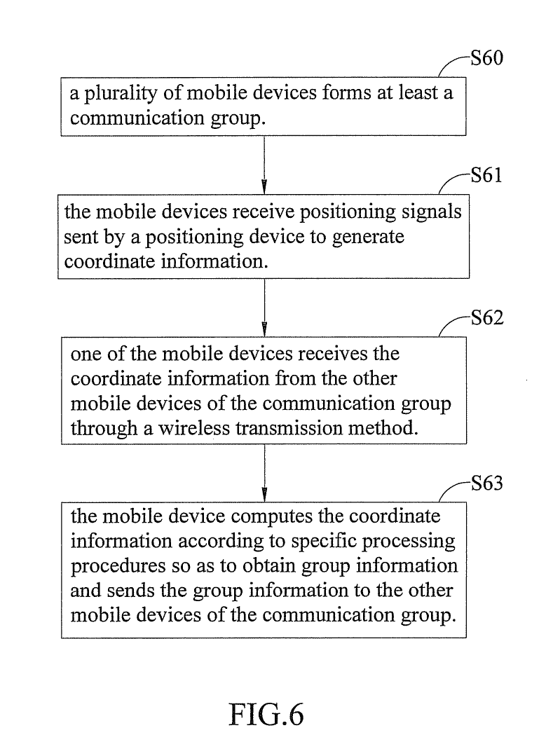

FIG. 6 is a flow chart showing a data processing method integrated with positioning technology according to an embodiment of the present invention. The method comprises the following steps.

At step S60, a plurality of mobile devices form at least a communication group. Then, the process goes to step S61.

At step S61, the mobile devices receive positioning signals sent by a positioning device to generate coordinate information. Then, the process goes to step S62.

At step S62, one of the mobile devices receives the coordinate information from the other one or more of the plurality of mobile devices of the at least one communication group through a wireless transmission method. Then, the process goes to step S63.

At step S63, the mobile device computes the coordinate information according to specific processing procedures so as to obtain group information and send the group information to the other one or more of the plurality of mobile devices of the at least one communication group. Therein, the group information is status information, location information, grouping information, scoring information or motion strategy information of the mobile devices.

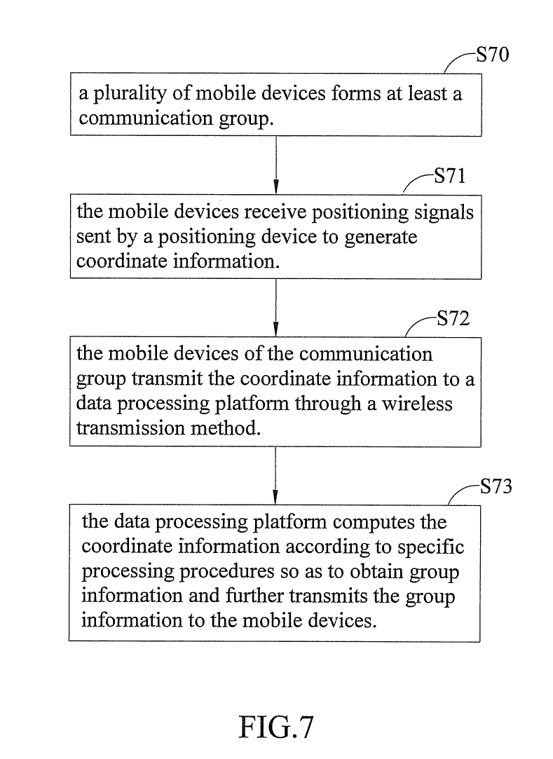

FIG. 7 is a flow chart showing a data processing method integrated with positioning technology according to another embodiment of the present invention. The method comprises the following steps.

At step S70, a plurality of mobile devices form at least a communication group. Then, the process goes to step S71.

At step S71, the mobile devices of the at least one communication group receive positioning signals sent by a positioning device to generate coordinate information. Then, the process goes to step S72.

At step S72, the mobile devices of the at least one communication group transmit the coordinate information to a data processing platform via a wireless transmission method. Then, the process goes to step S73.

At step S73, the data processing platform computes the coordinate information according to specific processing procedures so as to obtain group information and then transmit the group information to the mobile devices.

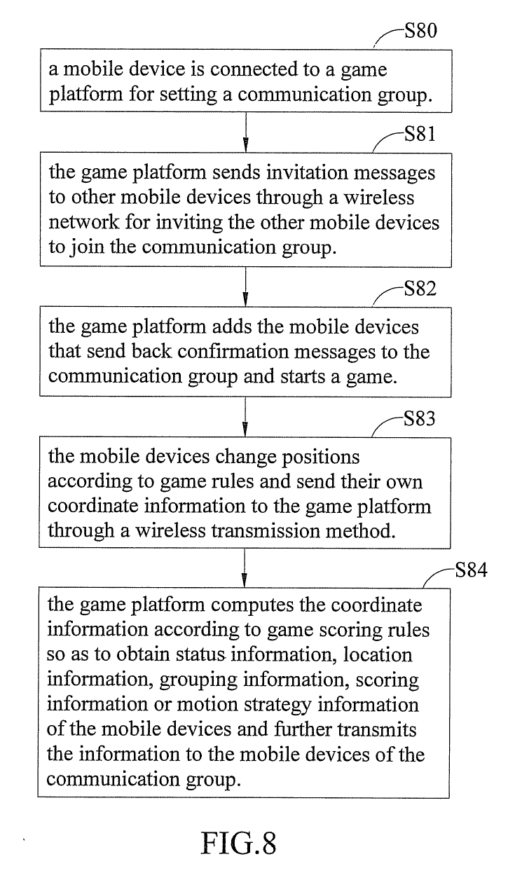

FIG. 8 is a flow chart showing a data processing method applied in an urban game according to an embodiment of the present invention. As shown in the drawing, the method comprises the following steps.

At step S80, a mobile device is connected to a game platform for setting a communication group thereof. Then, the process goes to step S81.

At step S81, the game platform sends invitation messages to the other one or more of the plurality of mobile devices positioned proximate to the mobile device through a wireless network for inviting the other one or more of the plurality of mobile devices to join the at least one communication group for a multiplayer game. Then, the process goes to step S82.

At step S82, the game platform adds the mobile devices that send back confirmation messages to the at least one communication group and starts a game. Then, the process goes to step S83.

At step S83, the mobile devices change positions according to game rules and send their own coordinate information to the game platform through a wireless transmission method. Then, the process goes to step S84.

At step S84, the game platform computes the coordinate information according to game scoring rules so as to obtain status information, location information, grouping information, scoring information or motion strategy information of the mobile devices and then transmits the information to the mobile devices of the at least one communication group.

According to the present invention, a plurality of mobile devices establish a communication group, transmit coordinate information to one another and compute the coordinate information through specific processing procedures so as to expand the application of positioning technology and enhance interaction among users.

Therefore, the data processing system and method integrated with positioning technology of the present invention can achieve the following effects:
(1) increasing users' interaction. In the prior art, users can only passively obtain coordinate information through a positioning device and they cannot interact with one another. In the present invention, a plurality of mobile devices form a communication group and integrate with positioning technology such that users can obtain coordinate information from one another while they are moving, thereby increasing interaction among users.
(2) expanding the application of positioning technology. The conventional positioning technology is constrained by its own structure and can only be applied to individual navigation and positioning or dynamic location queries. The present invention integrates mobiles devices with positioning technology so as to expand the application area of the positioning technology to urban games, location-based games, wild adventures or group activities, thereby enhancing the commercial value of the positioning technology.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

What is claimed is:

1. A data processing system integrated with positioning technology, comprising:
a positioning device for sending positioning signals; and
a plurality of mobile devices for processing, receiving and transmitting data, wherein each of the plurality of mobile devices comprises:
a positioning signal processing module for receiving the positioning signals to generate coordinate information;
a wireless signal transceiver module for receiving and transmitting wireless signals; and
a data computation module for computing the coordinate information,
wherein the plurality of mobile devices form at least a communication group, allowing one of the plurality of mobile devices of the at least a communication group to receive the coordinate information from the other one or more of the plurality of mobile devices of the at least a communication group via the wireless signal transceiver module, so as for the data computation module to compute the coordinate information to obtain group information and then transmit the group information via the wireless signal transceiver module, such that all of the plurality of mobile devices of the at least a communication group are allowed to obtain the group information.

2. The system of claim 1, wherein one of the plurality of mobile devices of the at least a communication group is allowed to be selected to exchange the group information with the other one or more of the plurality of mobile devices of the other one or more of the at least a communication group, so as for the group information to be communicated among different ones of the at least a communication group.

3. The system of claim 1, wherein the one of the plurality of mobile devices is provided with a talk function for transmitting data to and receiving data from the other one or more of the plurality of mobile devices via the wireless signal transceiver module, so as for the one of the plurality of mobile devices to receive the coordinate information from the other one or more of the plurality of mobile devices through the talk function, and to then compute the coordinate information according to specific processing procedures in order to generate the group information and then transmit the group information to the other one or more of the plurality of mobile devices.

4. The system of claim 3, wherein the one of the plurality of mobile devices is provided with a broadcast function by which the group information is transmitted to the other one or more of the plurality of mobile devices.

5. The system of claim 3, wherein the one of the plurality of mobile devices is provided with a host function for communicating with the other one or more of the plurality of mobile devices so as to invite the other one or more of the plurality of mobile devices to join the at least a communication group.

6. The system of claim 1, further comprising a data processing platform for receiving the coordinate information from the plurality of mobile devices, computing the coordinate information according to the specific processing procedures so as to obtain the group information, and then transmitting the group information to the plurality of mobile devices.

7. The system of claim 1, further comprising a coordinate reference device for receiving the coordinate information of the plurality of mobile devices, computing the coordinate information according to the specific processing procedures so as to obtain the group information, and then transmitting the group information to the plurality of mobile devices.

8. The system of claim 1, wherein the positioning device is a GPS positioning satellite, a Galileo satellite, a wireless network positioning device, or a mobile communication base station.

9. The system of claim 1, wherein the wireless signal transceiver module receives and transmits wireless LAN signals or wireless WAN signals.

10. The system of claim 1, wherein the mobile devices are smart phones, PDAs, or portable computers.

11. The system of claim 1, wherein the mobile devices further comprise electronic map software for displaying relative position, moving path, or route planning of the mobile devices of the at least a communication group according to the coordinate information.

12. The system of claim 1, wherein the group information is status information, location information, grouping information, scoring information, or motion strategy information of the plurality of mobile devices.

13. The system of claim 3, wherein the specific processing procedures involve computing the coordinate information according to software predefined flows, rules, or methods.

14. A data processing method integrated with positioning technology, applied to a system having a positioning device and a plurality of mobile devices, the method comprising the steps of:
(1) commanding the plurality of mobile devices to form at least a communication group;
(2) commanding the plurality of mobile devices to receive positioning signals from the positioning device to generate coordinate information;
(3) commanding one of the plurality of mobile devices to receive the coordinate information from other one or more of the plurality of mobile devices of the at least a communication group via a wireless transmission approach; and
(4) commanding the one of the plurality of mobile devices to compute the coordinate information according to specific processing procedures to obtain group information and then transmit the group information to the other one or more of the plurality of mobile devices of the at least a communication group.

15. The method of claim 14, wherein step (1) further comprises the steps of:
(1-1) commanding one of the plurality of mobile devices to set to join the at least a communication group and start a talk function for transmitting data to one another via a wireless signal transceiver module; and
(1-2) commanding the one of the plurality of mobile devices to talk with other one or more of the plurality of mobile devices for inviting the other one or more of the plurality of mobile devices to join the at least a communication group.

16. The method of claim 14, wherein the group information is status information, location information, grouping information, scoring information, or motion strategy information of the plurality of mobile devices of the communication group.

17. The method of claim 14, wherein the processing procedures involve computing the coordinate information according to software predefined flows, rules, or methods.

18. A data processing method integrated with positioning technology, applied to a system having a positioning device, a plurality of mobile devices and a data processing platform, the method comprising the steps of:
(1) commanding the plurality of mobile devices to form at least a communication group;
(2) commanding the plurality of mobile devices of the at least a communication group to receive positioning signals from the positioning device to generate coordinate information;
(3) commanding the plurality of mobile devices of the at least a communication group to transmit the coordinate information to the data processing platform via a wireless transmission method; and
(4) commanding the data processing platform to compute the coordinate information according to specific processing procedures so as to obtain group information and then transmit the group information to the plurality of mobile devices of the at least a communication group.

19. The method of claim 18, wherein step (1) further comprises the steps of;
(1-1) commanding one of the plurality of mobile devices to connect the data processing platform to set to join the at least a communication group;
(1-2) commanding the data processing platform to send messages to the mobile devices close to the one of the plurality of mobile devices for inviting them to join the at least a communication group; and
(1-3) commanding the data processing platform to add the mobile devices close to the one of the plurality of mobile devices and send back confirmation messages into the at least a communication group.

20. The method of claim 18, wherein the group information is status information, location information, grouping information, scoring information, or motion strategy information of the plurality of mobile devices of the communication group.

21. The method of claim 18, wherein the processing procedures involve computing the coordinate information according to software predefined flows, rules, or methods.
